(19) United States
(12) Patent Application Publication
(10) Pub. No.: US 2012/0282808 A1
(43) Pub. Date: Nov. 8, 2012

(54) ELECTRICAL CONNECTOR WITH CONNECTING BARS THEREIN TO REDUCE CROSS TALKING

(75) Inventors: YU LUO, Shenzhen (CN); XING-LIANG LIU, Shenzhen (CN)

(73) Assignee: HON HAI PRECISION INDUSTRY CO., LTD., New Taipei (TW)

(21) Appl. No.: 13/459,084

(22) Filed: Apr. 28, 2012

(30) Foreign Application Priority Data
May 3, 2011 (CN) 201120136325.4

(51) Int. Cl. H01R 13/648; H01R 31/06

(52) U.S. Cl. 439/607.28; 439/628

(57) ABSTRACT

sa An electrical connector includes an insulating housing defining an uninterrupted tongue portion with opposite first surface and second surface and a plurality of contacts loaded in the tongue portion. The contacts includes a first group of contacts with first contacting portions loaded in the first surface, a second group of contacts with second contacting portions loaded in the second surface. Each of the first and second group of contacts is composed of signal contacts and grounding contacts and a connecting bar is assembled to electrically connect at least one first grounding contact and one second grounding contact.

### BACKGROUND OF THE INVENTION

1. Field of the Invention

The present invention generally relates to an electrical connector, and more particularly to an electrical connector capable of high speed and backwards compatibility with relative lower high speed.

2. Description of Related Art

Serial Attached SCSI (SAS) is a successor to the parallel SCSI and is also based on serial technology. Besides the advantage of higher speed signal transmission, another most significant advantage is that the SAS interface will also be compatible with SATA drives. In other words, the SATA plug connector can plug directly into a SAS receptacle connector if supported in the system. By this way, the system builders are flexible to integrate either SAS or SATA devices and slash the costs associated with supporting two separate interfaces.

U.S. Pat. No. 6,942,524 discloses a SAS connector for SAS 2.0 standard transmitting 6.0 Gbps. Higher signal transmission is a tendency in high speed industry. Connectors adapted for speed higher than 6.0 Gbps is developing. Questions of electrical performance, such as cross talk, signal attenuation arises. Particularly, crosstalk is a major issue at 12 Gbps. So, we hope design an electrical connector to overcome said question.

### SUMMARY OF THE INVENTION

Accordingly, an object of the present invention is to provide electrical connectors capable to high speed.

In order to achieve the object set forth, an electrical connector includes an insulating housing defining an uninterrupted tongue portion with opposite first surface and second surface and a plurality of contacts loaded in the tongue portion. The contacts includes a first group of contacts with first contacting portions loaded in the first surface, a second group of contacts with second contacting portions loaded in the second surface. Each of the first and second group of contacts is composed of signal contacts and grounding contacts and a connecting bar is assembled to electrically connect at least one first grounding contact and one second grounding contact.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector of a first embodiment in accordance with the present invention;

FIG. 2 is an exploded perspective view of the electrical connector shown in FIG. 1;

FIG. 3 is another exploded perspective view of the electrical connector shown in FIG. 1;

FIG. 4 is a perspective view of contacts of the electrical connector shown in FIG. 1;

FIG. 5 is a cross section view of the electrical connector taken along a broken line 5-5 in FIG. 1;

FIG. 6 is an exploded view of an electrical connector of a second embodiment in accordance with the present invention, with the connecting bar separated from the insulative housing;

FIG. 7 is a cross sectional view similar to FIG. 5 to show the connector of the second embodiment of the present invention; and

FIG. 8 is an exploded view of an electrical connector of the third embodiment in accordance with the present invention, with the connecting bar separated from the insulative housing.

### DETAILED DESCRIPTION OF THE INVENTION

Reference will now be made in detail to the preferred embodiment of the present invention.

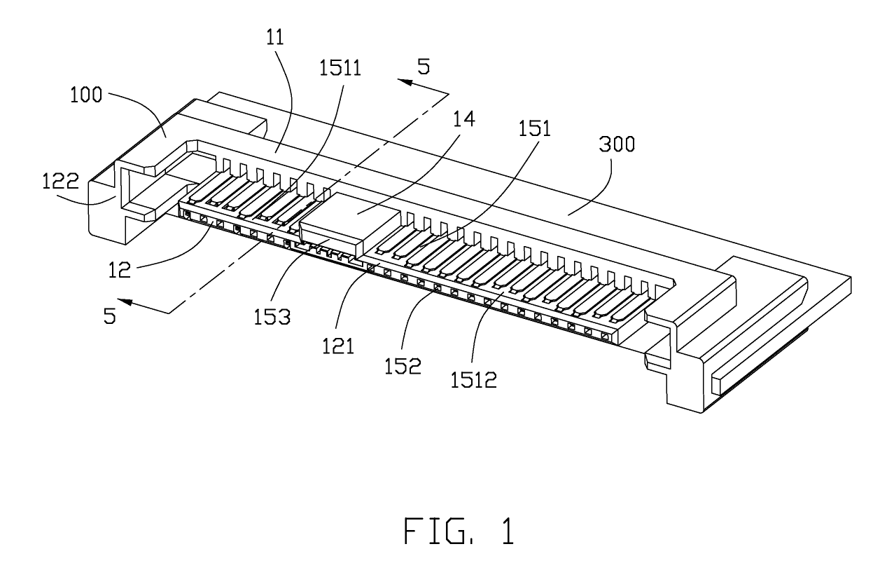

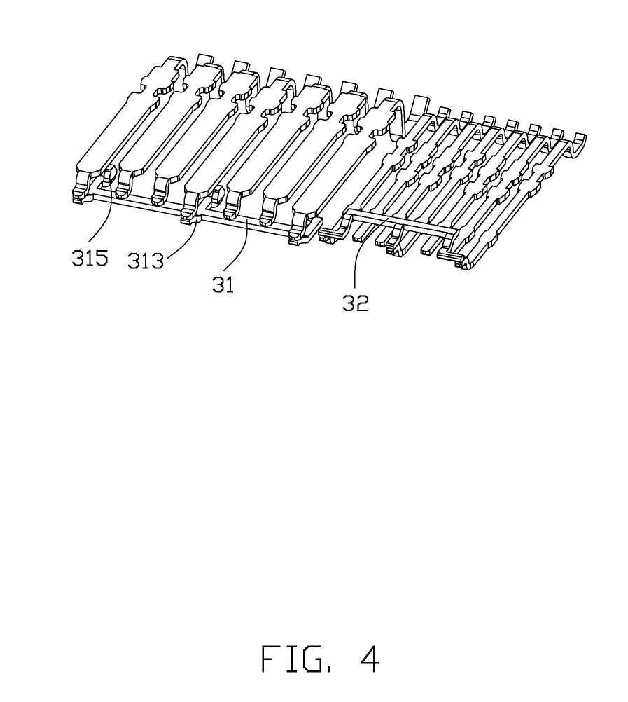

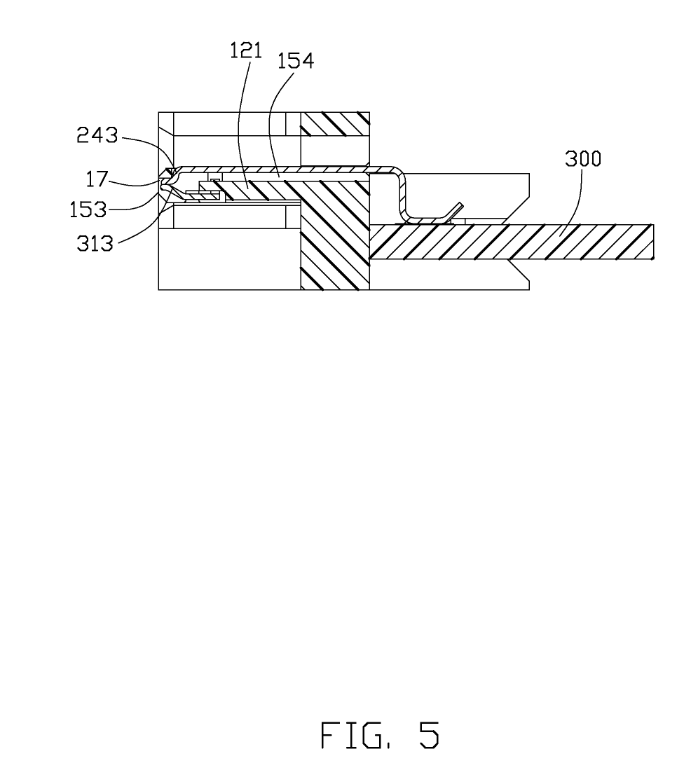

Referring to FIGS. 1-5, an electrical connector 100 mounted on a PCB 300 is used for providing interfaces for a high speed storage device, especially for SAS signal transmission which is capable to 12 Gbps operation.

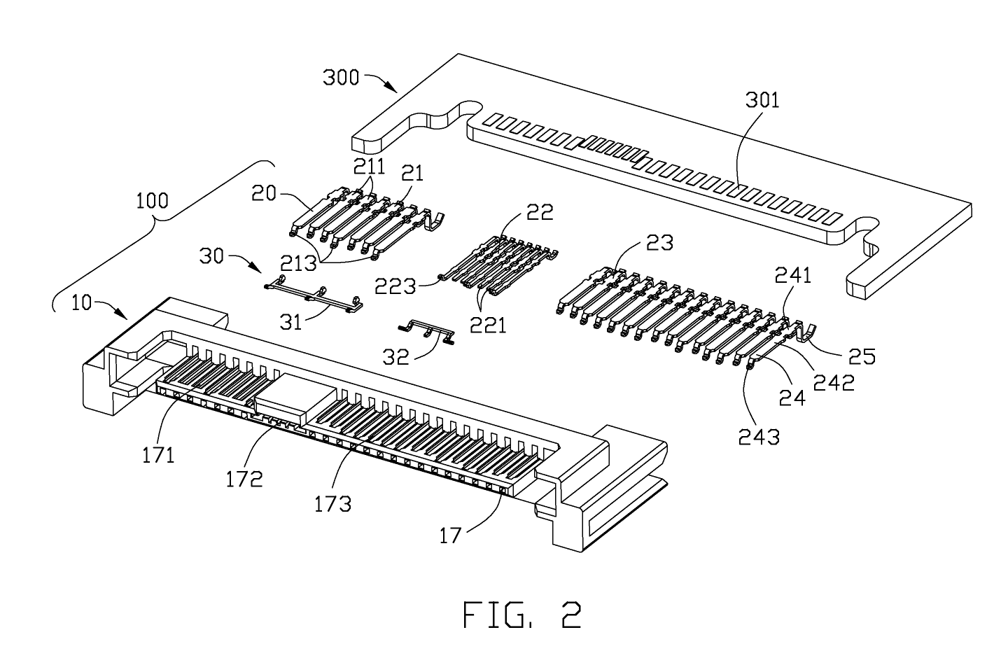

Referring to FIGS. 1 and 2, the electrical connector 100 includes an insulative housing 10 and a plurality of contacts 20 (including first contacts 21, second contacts 22 and third contacts 23) received in the insulative housing 10. The insulative housing 10 defines a lengthwise direction and a transverse direction perpendicular to each other and comprises a rear wall 11 and an elongated mating portion 12 which is formed by an uninterrupted tongue portion 121 and a pair of guiding portions 122 of an inverted U shape commonly extending from the rear wall 11. The tongue portion 121 extends along the lengthwise direction and defines opposite first and second surfaces 151, 152 arranged in said transverse direction and a rib 14 is formed at the first surface 151 unitarily extending forwards from the rear wall 11 to a front surface 153. The rib 14 divides the first surface 151 into a first sub surface 1511 and a second sub surface 1512 and the second sub surface 1512 is larger than the first sub surface 1511 along the lengthwise direction. The contacts 21, 22, 23 are respectively loaded in first passageways 171 located on the first sub surface 1511, a second passageways 172 located on the second surface 152 and third passageways 173 located on the second sub surface 1512.

The first sub surface 1511 is loaded with a group of seven first contacts 21 in corresponding passageways 171 not through the front face, which is functioned as a signal segment S1-S7 defined in SAS 2.0 Specification. The second surface 152 is loaded with a group of seven second contacts 22 in the passageways 172 through the front face of the mating portion, which is functioned as a signal segment S8-S14 defines in SAS 2.0 Specification. The second sub surface 1512 is loaded with a group of fifteen third contacts 23 in the passageways 173 through the front face of the mating portion, which is functioned as a power segment P1-P15 defines in SAS 2.0 Specification. Please note, both of the first and second contacts 21, 22 are arranged in a pattern with G-S(+)-S(−)-G-S(+)-S(−)-G-S(+)-S(−), So three contacts of each group of contacts are of grounding contacts, which are labeled with numerals 213, 223. The signal contacts are labeled with numerals 211, 221.

The contacts 20 in every segment have same configure, so we take the first contacts 21 for instance. Each first contact 21 is of a plate type by cutting a metal sheet and includes a retaining portion 24 with barbs 241 at a side edge thereof, a plate mating portion 242 at a front free end thereof and a tail portion 25 at a rear free end to contact with a printed circuit spot 301 of the PCB 300. The plate mating portion 242 and the tail portion 25 extend from opposite lateral sides of the retaining portion 24. The plate mating portion 242 of each first contact 21 is parallel and level to the first surface 151. An opening 17 is depressed from the front surface 153 and communicating with the passageways 171, and the free end of each plate mating portion 242 forms a hook portion 243 receiving in the opening 17.

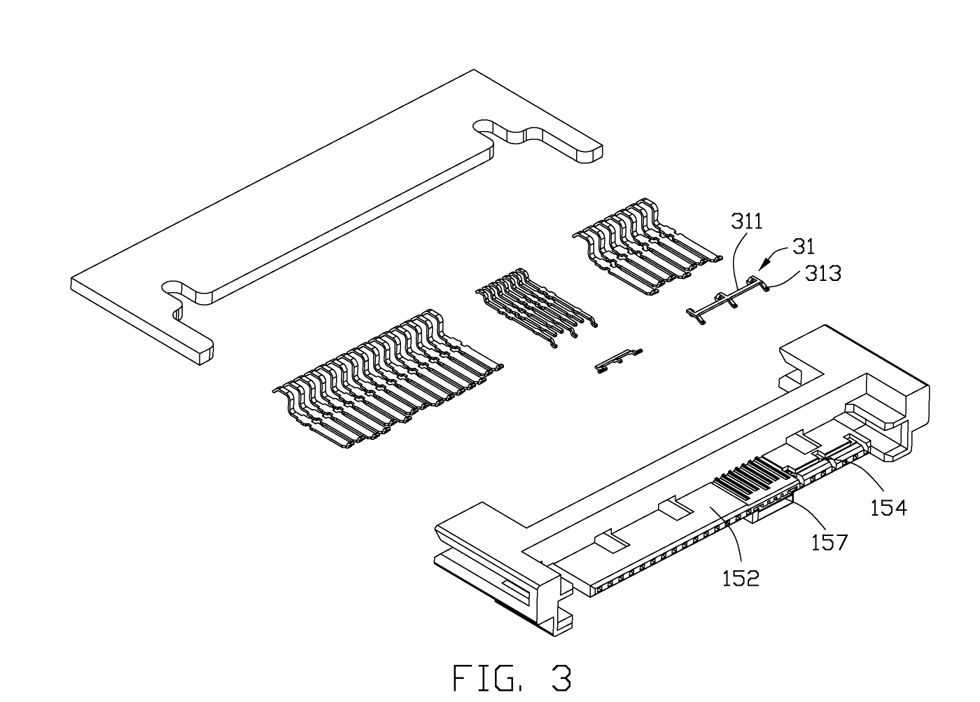

Referring to FIGS. 3 to 5, the second surface 152 opposite to the first sub surface 1511 forms a first cavity 154 communicating with the first passageways 171 for receiving a first grounding bar 31. The first grounding bar 31 comprises an elongated connecting base 311, three elastic fingers 313 extending toward the first contact 21 and a retaining barbs 315 engaging with the first cavity 154 along the transverse direction. After assembled into the first passageways 171, the three elastic fingers 313 touches and electrically connects the hook portion 243 of the first contact 21 to connecting said three grounding contacts together. The front surface 153 of the rib 14 forms a second cavity 157 communicating with the second passageways 172 for receiving a second grounding bar 32 and also forms three elastic fingers to connect corresponding second contact 22. The connecting bars 31, 32 connecting the grounding contacts 213,223 will reduce the crosstalk. Therefore, the electrical connector 100 can be used to transport high speed up to 12 Gbps. Moreover, the electrical connector is same to the designation of the connectors in SAS 2.0 Specification in dimension and pin arrangement which has a high speed capable to 6 Gbps except the addition of the grounding bars. Using a same interface, the connectors of this present invention speed signal transmission up to 12 Gbps.

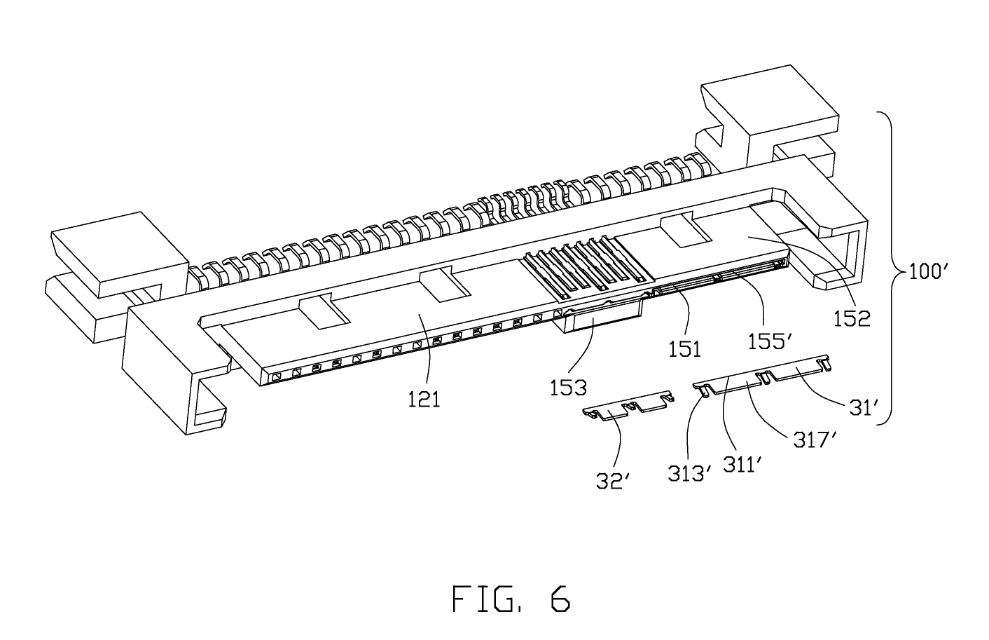

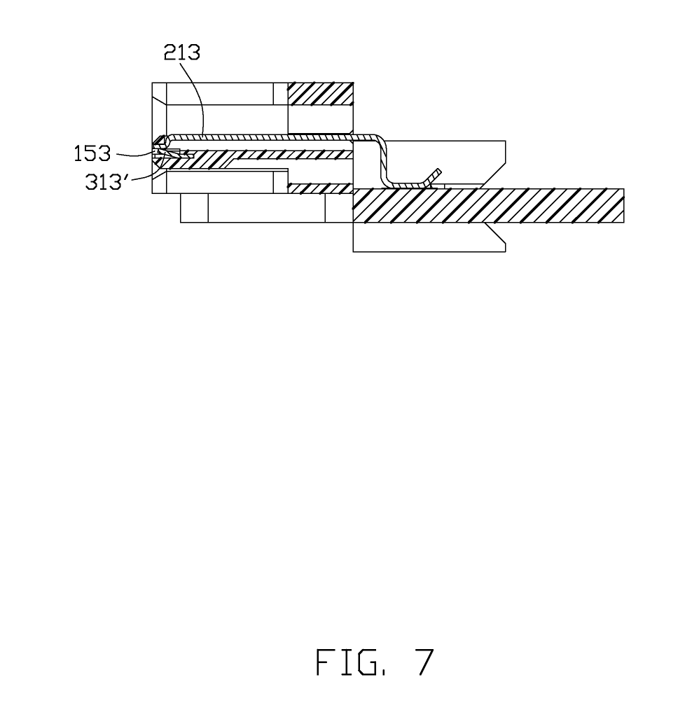

FIGS. 6 and 7 show a second embodiment of the invention, which give an illustration of an electrical connector 100′ wherein description of same and similar element are omitted. The first connecting bar 31′ is of a plate type and each comprises an elongated base 311′, three elastic fingers extending toward the first surface 151 and two shielding sheets 317′ located between the first surface 151 and the second surface 152. The front surface 153 forms a first cavity 155 communicating with the first passageways for receiving the first grounding bar 31′. The second connecting bar 32′ has the similar structure with the first connecting bar 31′, the difference is the elastic fingers 313′ of the second connecting bar 32′ extends toward the second surface 152 opposite to the first one.

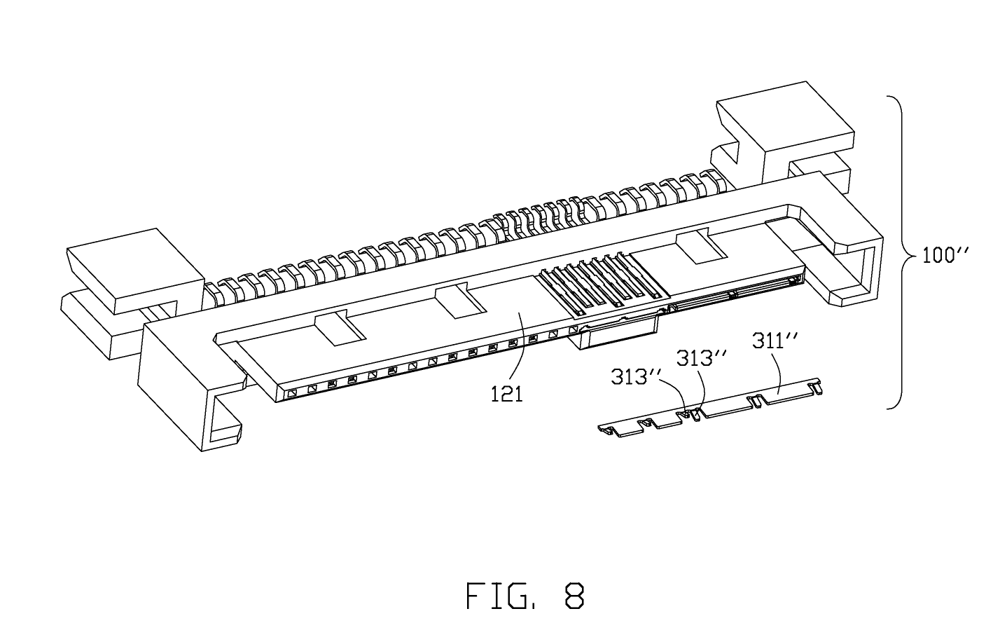

FIG. 8 shows electrical connector 100″ of a third embodiment of the invention. The electrical connector 100″ forms an uncorrupted cavity extending along the lengthwise direction corresponding to the first contact and the second contact. A unitarily connecting bar 311″ is assembled into the cavity with elastic fingers 313″ connecting the first and second grounding contacts in different surfaces.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An electrical connector comprising:
an insulating housing defining an uninterrupted tongue portion with opposite first surface and second surface; and
a plurality of contacts loaded in the tongue portion, and comprising a first group of contacts with first contacting portions loaded in the first surface, a second group of contacts with second contacting portions loaded in the second surface; wherein
each of the first and second group of contacts is composed of signal contacts and grounding contacts, and a connecting bar is formed to electrically connect at least one first grounding contact and one second grounding contact.

2. The electrical connector as claimed in claim 1, wherein the connecting bar is assembled into the insulative housing from a front face of the tongue portion.

3. The electrical connector as claimed in claim 1, wherein the connecting bar is located between the first surface and the second surface.

4. The electrical connector as claimed in claim 1, wherein the first group of contacts includes at least one differential pair contacts for signal transmission and two first grounding contacts alternately arranged with each other along the lengthwise direction, the two first grounding contacts are electrically connected by the connecting bar.

5. The electrical connector as claimed in claim 1, wherein the connecting bar comprises a number of first fingers bending towards the first surface to contact corresponding first grounding contacts and a number of second fingers bending towards the second surface to contact corresponding second grounding contacts.

6. The electrical connector as claimed in claim 5, wherein an opening is depressed from the front surface for receiving a hook portion formed on a free end of each grounding contact and the connecting bar is electrically attached on the hook portion.

7. An electrical connector comprising:
an insulating housing defining a first mating surface; and
a plurality of contacts loaded on the first mating surface, the contacts comprising two grounding contacts and a differential pair contacts located between the two grounding contacts; wherein
a connecting bar is defined to electrically connect the two first grounding contacts; the connecting bar comprises a bridge base, two elastic fingers extending from one side of the bridge base for contacting with the first grounding contacts and a shielding sheet extending from the same side of the bridge base.

8. The electrical connector as claimed in claim 7, wherein the bridge base is leading the insertion of the connecting bar.

9. The electrical connector as claimed in claim 7, wherein the shielding sheet is of a flat type, and elastic fingers are respectively splited out from both side of the shielding sheet.

10. The electrical connector as claimed in claim 9, wherein the insulating housing defines a contact arranging direction paralleling to the first mating surface, the shielding sheet and the elastic fingers are alternately arranged in the contact arranging direction.

11. The electrical connector as claimed in claim 10, wherein the insulating housing defines a second mating surface opposite to the first mating surface and the connecting bar comprises a number of first fingers bending toward the first mating surface to contact corresponding first grounding contacts and a number of second fingers bending towards the second surface to contact second grounding contacts located on the second surface.

12. An electrical connector comprising:
an insulative housing defining a mating plate extending along a longitudinal direction, said mating plate defining opposite first and second surfaces;
a plurality of first contacts disposed in the housing with first contacting sections exposed upon the first surface;
a plurality of second contacts disposed in the housing with second contacting sections exposed upon the second surface;
a first connecting bar and a second connecting bar essentially located between the first surface and the second surface in a front view; wherein
the first connecting bar extends in the longitudinal direction with some first spring tangs extending toward and abutting against the corresponding first contacting sections, respectively. and the second connecting bar extends in the longitudinal direction with some second spring tangs extending toward and abutting against the corresponding second contact sections, respectively.

13. The electrical connector as claimed in claim 12, wherein the first connecting bar and the second connecting bar are located at a front edge region of the mating plate.

14. The electrical connector as claimed in claim 12, wherein each of the first connecting bar and the second connecting bar defines a plurality of notches in which the corresponding first and second spring tangs are located.

15. The electrical connector as claimed in claim 12, wherein a rib is formed on the first surface opposite to an area of the second surface occupied by the second contacting sections in a vertical direction perpendicular to said longitudinal direction, and said rib is configured to allow the second connecting bar to be assembled thereinto in a front-to-back direction perpendicular to both said longitudinal direction and said vertical direction.

16. The electrical connector as claimed in claim 12, wherein the second surface is configured to allow the second connecting bar to be assembled thereinto in a vertical direction perpendicular to said longitudinal direction.

17. The electrical connector as claimed in claim 12, wherein one of said first spring tangs and one of the second spring tangs are intimately neighboring with each other.

18. The electrical connector as claimed in claim 12, wherein the first connecting bar and the second connecting bar are unitarily joined with each other as one piece in the longitudinal direction.

19. The electrical connector as claimed in claim 18, wherein the front edge of the mating plate defines passage to allow the longitudinal joined first bar and second connector bar to be inserted thereinto in a front-to-back direction perpendicular to said longitudinal direction.

20. The electrical connector as claimed in claim 12, wherein the spring tangs cooperate with the mating plate to sandwich tips of the corresponding contacting sections, respectively, in a vertical direction perpendicular to said longitudinal direction.
